(19) United States
(12) Patent Application Publication
(10) Pub. No.: US 2011/0253244 A1
(43) Pub. Date: Oct. 20, 2011

(54) HOSE WITH IMPROVED FLOW

(75) Inventors: David LORD, Compton (CA); Joël HERAUD, Sherbrooke (CA); Yannick HARVEY, Sherbrooke (CA)

(73) Assignee: NIEDER INC., Coaticook (CA)

(21) Appl. No.: 13/090,071

(22) Filed: Apr. 19, 2011

Related U.S. Application Data
(60) Provisional application No. 61/325,632, filed on Apr. 19, 2010.

(51) Int. Cl. F16L 11/20; B29C 47/88

(52) U.S. Cl. 138/124; 156/244.13

(57) ABSTRACT

A hose with an improved flow includes a method of manufacture of the same. The hose with an improved flow includes an extruded inner tube and a non-woven material layer disposed over the extruded inner tube. The layer of non-woven material is in direct contact with the extruded inner tube and is fused thereto. The hose with an improved flow further includes at least one woven jacket disposed over and fused to the layer of non-woven material. The presence of the layer of non-woven material results in a smoother inner surface of the inner tube, which helps improve the flow of water in the hose, as well as in other favorable characteristics.

This application claims benefit of Ser. No. 61/325,632, filed 19 Apr. 2010 in the United States and which application is incorporated herein by reference. To the extent appropriate, a claim of priority is made to each of the above disclosed applications.

### FIELD OF THE INVENTION

The present invention relates to the field of lightweight hoses. More particularly, it relates to a hose with an improved construction that reduces the inner resistance to water and consequently improves the water flow. The new improved design also yields other advantages as described below.

### BACKGROUND OF THE INVENTION

The need for lightweight hoses that can flow large amounts of water, while providing great mobility to its users, has been acknowledged for several years, especially, but without limitation, by firefighters. Consequently, hose manufacturers have been producing such lightweight hoses in order to meet demand.

A commonly known design for these lightweight hoses is the double jacketed hose. One of the common construction method for a double jacketed hose includes extruding an inner tube, applying a heat activated adhesive to the outer surface of the tube, inserting the tube with the adhesive applied thereto into an inner woven jacket, inflating the inner tube with steam to cure the adhesive and bond the tube to the inner jacket, and, finally, inserting the inner jacket into the outer jacket.

Hoses produced using the above-mentioned method, however, tend to suffer from several drawbacks. One of these drawbacks is the roughness of the inner surface of the inner tube resulting from the bonding of the inner tube directly onto the inner surface of the inner jacket. The roughness creates friction with the flowing water and consequently reduces the overall flow of water in the hose. Moreover, over time, the bonding between the inner tube and the inner jacket tends to deteriorate, which results in the inner tube becoming loose. This looseness can lead to the detachment of the inner tube and result in the clogging of the hose.

Other construction methods for hoses were proposed over the years. For example, U.S. Pat. No. 4,738,735 to Joncker et al., discloses a method for continuously extruding an elastomeric material on the interior of a continuous tubular woven fabric in a loom. According to Joncker et al., the liner is applied as a hot melt coating at the weaving point in the loom. The extruder or coater is mounted directly over the loom and as the jacket is woven the extruder or coater leaves or applies a layer of hot melted urethane directly on the interior of the inner jacket created by the weaving. The inner jacket created by the Joncker process is then inserted into an outer jacket.

Moreover, U.S. Pat. No. 5,603,357 to Schomaker et al. teaches a fire hose comprising inner and outer jackets, where the inner jacket resides substantially in engagement with the outer jacket, the inner and outer jackets acting substantially as one unified construction. A smooth layer of polyurethane is formed on the interior surface of the inner jacket. In the case of hoses having a diameter of two inches or less, the layer of polyurethane is extruded onto the exterior of the inner jacket and the hose is subsequently reversed through a reversing step. For hoses having a diameter greater than two inches, the process described in Schomaker et al. includes the step of extruding a layer of polyurethane interiorly. According to Schomaker et al, the resulting polyurethane layer provides a smooth, low-friction interior surface for water flow.

The above-mentioned proposed solutions involve construction methods that are radically different than the above-described common construction method, and therefore require specific arrangement of manufacturing stations and/or specially designed components. Thus, significant investments are required for modifying a hose manufacture producing hoses according to the commonly used manufacture method, to a manufacture for manufacturing hoses according to the method described in Joncker, et al. or Schomaker et al. (where the inner tube is extruded directly onto the inner jacket).

Hence, in light of the above, there is presently a need for a hose and manufacture method which, by virtue of its design and components, would be able to overcome or at least minimize some of the above-discussed prior art problems, and provide a hose offering a minimal resistance to the water flowing within the inner tube and an improved bonding between the inner tube and the woven jacket while using a construction method that is not radically different from the commonly used, above-described, method.

### SUMMARY OF THE INVENTION

In accordance with an aspect of the present invention, there is provided a hose with an improved flow that comprises an extruded inner tube and a non-woven material layer disposed over the extruded inner tube. The non-woven material layer is in direct contact with the extruded inner tube and is fused to the extruded inner tube. The hose with an improved flow further comprises at least one woven jacket disposed over and fused to the layer of non-woven material.

Preferably, the at least one woven jacket of the hose with an improved flow comprises a woven inner jacket and a woven outer jacket.

In accordance with another aspect of the present invention, there is provided a method for manufacturing a hose with an improved flow. The method comprises the steps of extruding an inner tube having a fusion layer on its outer surface that is capable of fusing to a non-woven material layer by use of moderate heat. The method further provides that the inner tube is inserted into a non-woven material layer also comprising an outer fusion layer, and that the combined inner tube and non-woven material layer are inserted into at least one woven jacket. Subsequently, the combined inner tube, non-woven material layer and at least one woven jacket are heated to provide the fusing process, resulting in the fusing of the inner tube to the non-woven material layer and the fusing of the non-woven material layer to one of the at least one woven jacket.

Preferably, the step of inserting the combined inner tube and non-woven material layer into at least one woven jacket comprises a first step of inserting the combined inner tube and non-woven material layer into a woven inner jacket and a second step of inserting the combined inner tube, non-woven material layer and woven inner jacket into a woven outer jacket.

Still preferably, the heating of the combined layers can be provided by inserting internal steam into the inner tube.

Advantageously, the addition of the layer of non-woven material between the extruded inner tubing and the at least one woven jacket, in accordance with the above described hose with an improved flow and method of construction of the same, ensures that during the fusing process, the inner surface of the inner tubing maintains a substantially uniform surface. The resulting uniform surface of the inner tubing is achieved because of the inherent composition of the non-woven material layer that provides a flatter surface with a greater number of bonding areas in comparison to a woven jacket. The smoother resulting inner surface of the inner tubing yields a hose that has a greater flow of water than the conventional hoses with the same characteristics.

The addition of the layer of non-woven material also produces other desirable effects. One of these effects is an improvement in bonding caused by the microfibers in non-woven material that helps prevent delamination of the inner tubing. Another improvement is that the added layer of non-woven material helps resist pin holing during a period of time in the event of a jacket breach, by reinforcing the inner tube so that it can resist high pressures even in the event of a cut or hole in the at least one reinforcement jacket. Moreover, the addition of the non-woven material layer increases the overall thickness of the hose which helps resist kinking at low pressures.

Other features and advantages of the present invention will be better understood upon a reading of preferred embodiments thereof with reference to the appended drawings.

### BRIEF DESCRIPTION OF THE DRAWINGS

For a better understanding of the invention and to show how the same may be carried into effect, reference is now made by way of example to the accompanying drawings in which:

FIG. 1 is a schematic perspective view of a hose with an improved flow according to a preferred embodiment of the present invention, broken away in successive structural layers.

FIG. 2 is a cross-sectional view of the hose with an improved flow of FIG. 1.

FIG. 3 is a flowchart of a method of manufacture of a hose with an improved flow according to a preferred embodiment of the present invention.

### DETAILED DESCRIPTION OF THE INVENTION

In the following description, the same numerical references refer to similar elements. The embodiments, geometrical configurations, materials mentioned and/or dimensions shown in the figures or described in the present description are preferred embodiments only, given solely for exemplification purposes.

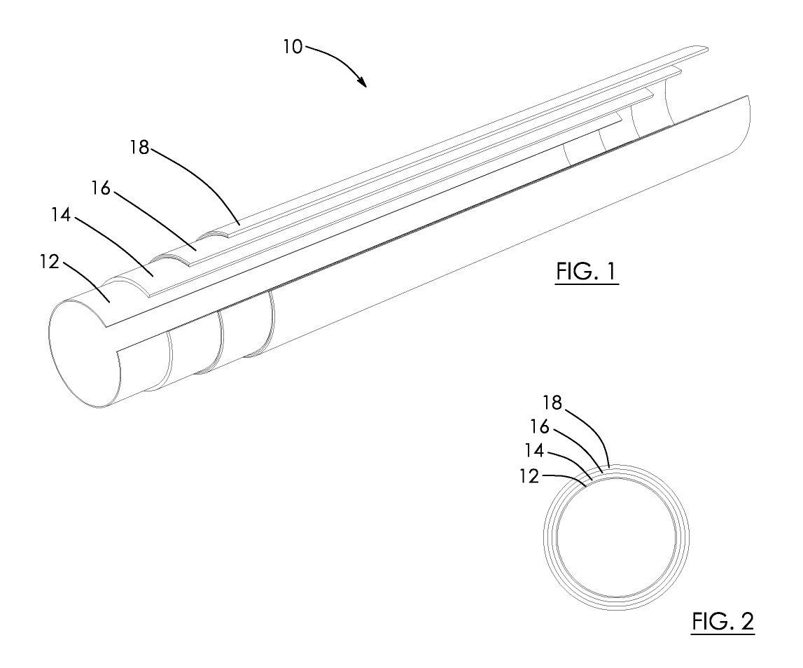

Referring to FIGS. 1 and 2, there is shown a representation of the different layers comprised in the hose with an improved flow, in accordance with one embodiment of the invention.

As shown in FIGS. 1 and 2, the hose with an improved flow 10 according to an embodiment of the present invention comprises an inner tube 12, a non-woven material layer 14 positioned directly over the inner tube 12 and fused thereto, a woven inner jacket 16 positioned over the layer of non-woven material 14 and fused thereto, and a woven outer jacket 18 positioned over the woven inner jacket 16.

In alternative embodiments, fewer or additional layers may be provided without departing from the scope of the present invention. For example, a protective additional layer made of rubber may be provided over the woven outer jacket 18, in order to offer additional protection to exterior elements and help prevent a jacket breach. Moreover, a single woven jacket or multiple woven jackets could be used in the manufacture of a hose with an improved flow.

In the above-described preferred embodiment, the inner tube 12 is made of a thermoplastic urethane material (TPU), the tube being formed by an extruding process. TPU is a lightweight material that offers great flexibility at low temperatures while providing excellent fungal and hydrolysis resistance. Moreover, since TPU has no volatiles, it is approved for use in hoses intended to flow potable water. However, as will be easily understood by one skilled in the art, other rubber or thermoplastic materials, or the like, could also be used in the manufacture of the inner tube 12 without departing from the scope of the present invention. Preferably, the thickness of the inner tube 12 will vary between 0.012″ to 0.025″, but could also be thicker or thinner. Also, the inner tube 12 has an outer surface that is capable of fusing to the non-woven layer by use of moderate heat.

An important feature of the present invention is the addition of a non-woven material layer 14 between the inner tube 12 and the inner jacket 16. Preferably, the layer of non-woven material 14 is made of felt, but several other non-woven materials could be used in the manufacture of the non-woven material layer 14.

Given that non-woven material usually does not come in a tubular form, the tubular shape of the non-woven material layer 14 is preferably achieved by manipulating the non-woven material such that the side extremities of an elongated piece of non-woven material are joined together, in order to create a layer of a tubular form, capable of containing the inner tubing 12. The joining of the two sides can be done according to known joining techniques such as heat welding, sewing, stitching, or gluing, or by using any other techniques resulting in the attachment of the two sides together. In alternative embodiments, other processes resulting in a tubular, non-woven material layer 14 could also be used in the manufacture of this layer and produce similar results regarding flow improvement and other identified advantages resulting from the addition of the non-woven material layer 14 between the inner tube 12 and the woven jacket.

As previously mentioned, and as illustrated in FIGS. 1 and 2, in the preferred embodiment, the layer of non-woven material 14 is covered and fused to a woven inner jacket 16 which is in turn covered by a woven outer jacket 18. The woven inner jacket 16 and woven outer jacket 18 can be made of any suitable material such as nylon, polyester, polyamide, Aramid, glass, rayon or any other natural or man-made fiber, and woven according to known techniques.

Typically, the inner 16 and outer 18 jackets are woven on a loom using warp threads running longitudinally with respect to the jacket and weft threads running helically along the jacket. As it is well known, the weaving of a jacket on a loom imparts a twist to the jacket, the twist causing a rotation of the jacket upon pressurization. As is also known, the direction of the imparted twist is dependent of the rotational direction of the weft thread during the weaving of the jacket (i.e. clockwise or counterclockwise). Thus, in order to minimize the overall twist of a hose having a double jacket, it is therefore common practice to use inner 16 and outer 18 jackets weaved in such a way as to have twists of opposite directions.

The above-described combination of jackets having opposite direction twists is preferably used for the inner jacket 16 and outer jacket 18 of the hose according to the preferred embodiment of the present invention. Preferably, the same material will be used in the manufacture of the inner 16 and outer 18 jackets, since it is easier to obtain a similar twist (of opposite direction), and similar elongation and burst characteristics when the two jackets are manufactured from the same material. However, different materials could be used in the composition of both jackets.

In order for the hose to perform properly, the diameter of each layer is such that the different layers fit tightly within one another.

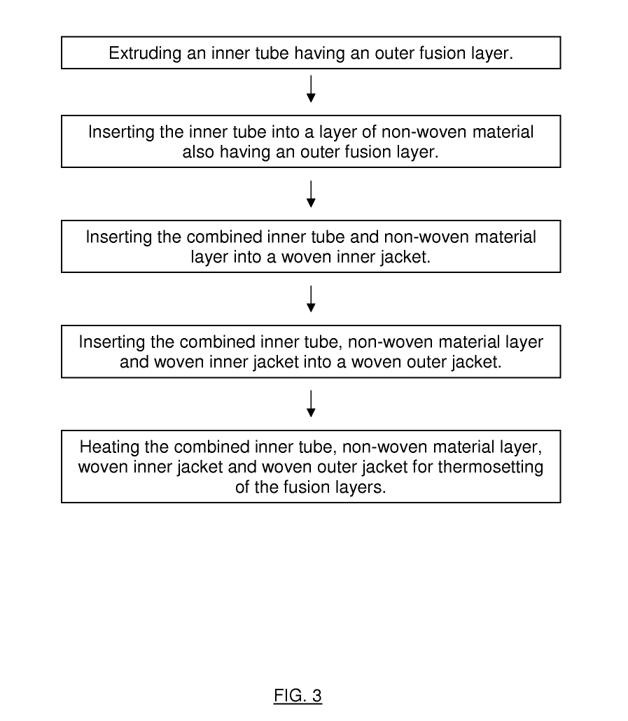

Now referring to FIG. 3, according to a preferred embodiment, the hose with an improved flow 10 is constructed in accordance with a construction method where an inner tube 12 is extruded, using an extruder with a dual channel head which forms an outer layer on the inner tube that can be easily heat fused. The inner tube 12, with the fusion layer applied thereto is then inserted into the non-woven material layer 14, which has also had a fusion layer applied to its outer surface, by means of a flat die extruder. For double jacket hoses such as the one described in the above-mentioned preferred embodiment, the combined inner tube 12 and non-woven material layer 14 are subsequently inserted into the woven inner jacket 16 and woven outer jacket 18.

The combined inner tube 12, non-woven material layer 14, woven inner jacket 16 and woven outer jackets 18 are subsequently heated for thermosetting of the fusion layers, which results in the fusing of the outer surface of the inner tube 12 to the inner surface of the non-woven material layer 14, and fusing of the outer surface of the non-woven material layer 14 to the inner surface of the woven inner jacket 16. Preferably, heat is provided by inserting internal steam into the inner tube 12. However, other suitable heat source, such as external hot air, could be provided without departing from the scope of the present invention.

The above mentioned steps do not need to occur in the sequential order in which they are presented above. For example, the steam pressure could be inserted into the inner tube 12 before insertion in the woven outer jacket 18, without departing from the scope of the present invention.

In alternative embodiments, other construction methods resorting to different operations and/or assembly techniques which would result in a hose with an improved flow 10 having the combination of layers according to the present invention, could also be used.

It should be noted that, fusion is not required at the interface between the outer surface of the inner jacket 16 and the inner surface of the outer jacket 18, the friction between the layers providing a sufficient mechanical interlock therebetween.

Preferably, the hoses 10 produced in accordance with the present invention will range in diameter between 1 and 24 inches in order to accommodate different needs regarding the flow of water through the hose 10. Once again, the range of hose diameter is provided for exemplification purposes only and one skilled in the art will understand that a hose having a larger or smaller diameter could be produced in accordance with the above mentioned principles without departing from the scope of the present invention.

From an outer point of view, the hose with an improved flow 10 looks similar to a conventional hose. However, the presence of the non-woven material layer 14 between the inner tubing 12 and one of the at least one woven jacket (the woven inner jacket 16 in the case of double jacketed hoses) allows, among other things, the creation of a smoother inner surface of the inner tube 12 following the fusion by thermosetting of the inner tube 12, than it is possible when the inner tube 12 is fused directly to a woven jacket. As previously mentioned, the resulting smoother surface of the inner tube 12 is achieved because of the inherent composition of the non-woven material layer 14 that provides a flatter surface with a greater number of bonding areas in comparison to a woven jacket, and allows a greater flow of water through the hose than that of traditional hoses free of such a layer of non-woven material 14.

Additional advantages also result from the presence of the non-woven material layer, such as an improvement in bonding resulting from the microfibers present in the non-woven material which helps prevent delamination of the inner tube 12. The improvement in bonding therefore reduces the risks of clogging of the hose caused by the formation of a blocking element resulting from the separation of inner tube 12 as a consequence of the rupture of the inner tube 12. Moreover, the added layer of non-woven material 14 helps resist pin holing during a period of time in the event of a jacket breach and provides an increase of the overall thickness of the hose which results in a greater resistance to kinking at low pressures.

The addition of a layer of non-woven material 14 between the inner tubing 12 and one of the at least one woven jacket, also has the advantage of producing all the above-mentioned advantageous characteristics without requiring major modifications to the traditional method for manufacturing hoses.

It will be readily understood by one skilled in the art that the above-mentioned embodiments are merely illustrative of the possible specific embodiments which may represent principles of the present invention. Of course, numerous modifications could be made to the preferred embodiments described above without departing from the scope of the present invention as defined in the appended claims.

1. A hose with an improved flow comprising:
an extruded inner tube;
a non-woven material layer disposed over the extruded inner tube in direct contact therewith, the non-woven material layer being fused to the extruded inner tube;
at least one woven jacket disposed over the non-woven material layer, one of the at least one woven jacket being fused to the non-woven material layer.

2. The hose with an improved flow of claim 1, wherein the at least one woven jacket comprises:
a woven inner jacket disposed over the non-woven material layer in direct contact therewith, the woven inner jacket being fused to the non-woven material layer;
a woven outer jacket disposed over the woven inner jacket in direct contact therewith.

3. A method for manufacturing a hose with an improved flow, the method comprising the steps of:
a) extruding an inner tube having a fusion layer on an outer surface of the inner tube;
b) inserting the inner tube into a non-woven material layer, the non-woven material layer also comprising an outer fusion layer;
c) inserting the combined inner tube and non-woven material layer into at least one woven jacket;
d) heating the combined inner tube, non-woven material layer and at least one woven jacket for thermosetting of the fusion layers.

4. The method for manufacturing a hose with an improved flow of claim 3, wherein step c) further comprises:
a first step of inserting the combined inner tube and non-woven material layer into a woven inner jacket;
a second step of inserting the combined inner tube, non-woven material layer and woven inner jacket into a woven outer jacket.

5. The method for manufacturing a hose with an improved flow of claim 3, wherein the heating step presented as step d) comprises inserting internal steam into the inner tube.

6. The method for manufacturing a hose with an improved flow of claim 4, wherein the heating step presented as step d) comprises by inserting internal steam into the inner tube.
